(19) United States
(12) Patent Application Publication
(10) Pub. No.: US 2005/0283388 A1
(43) Pub. Date: Dec. 22, 2005

(54) System and method for automotive liability insurance verification

(76) Inventors: David B. Eberwine, Lucas, TX (US); Mark A. Eberwine, San Antonio, TX (US)

Correspondence Address: Wilson Daniel Swayze, Jr., 3804 Clearwater Ct., Plano, TX, 75025, US

(21) Appl. No.: 11/154,502

(22) Filed: Jun. 16, 2005

Related U.S. Application Data
(60) Provisional application No. 60/580,215, filed on Jun. 17, 2004.

(51) Int. Cl. G06Q 40/00

(52) U.S. Cl. 705/4; 707/3

(57) ABSTRACT

A system and method for the real time verification of automobile liability insurance using multiple interconnected computer systems providing insurance verification to one or more validated users. The system utilizes user validation and indirect routing to both find and to protect the data source location. The system contains fraud prevention methods and methods of detecting system degradation. The system contains provisions to correct information discrepancies.

### BACKGROUND OF INVENTION

1. Field of Invention

This invention relates generally to the verification of information and more particularly to a system and method of verifying automobile insurance policy coverage in real time. The system also provides means to prevent fraud and automatically maintain system integrity.

2. Background Information

Currently, the state of Texas and multiple other states require proof of financial responsibility (liability insurance) for every registered vehicle operated on public roadways. Typically, that proof of insurance is a paper card carried in the glove compartment of the vehicle. The deficiencies of the current paper card based proof coverage is that the card is easily counterfeited (duplicated and created falsely) and the coverage was effective for the issuance of the card but is not necessarily in effect after the card was received by the insured. Also a percentage of motorists carry a card illegally obtained (either bought from a counterfeiter or printed by oneself). Additionally, insurance policies are started and then when the proof of insurance card is received by the insured, the insurance is cancelled yet the card is carried by the individual and presented as verification of a current policy even though there is no current insurance in effect. There currently is no timely, economical, real time method to verify that the insurance coverage indicated by the paper card is valid. The end result is the carrying of a card that does not indicate a nonexistent or canceled policy. Also, drivers can be ticketed in the morning for not having insurance and can purchase and have an active policy that afternoon but not have a current card. Insurance companies have resisted combining insurance data into a single database for centralized verification which enforcement agencies can access for fear of client information being accessed by a competitor or other unauthorized entity.

Multiple methods of improving compliance among motorist with state mandated minimum liability insurance laws exist today. All of the existing methods have shortcomings.

One method involves all insurance companies sending a snapshot of their insured customer database (called the “book of business” by the industry) to the specific state utilizing a method called “database compare”. The state takes the data from all insurance companies and compares that data to the state's registered vehicle database. Any registered vehicle which does not have a matching insurance company database entry is considered uninsured. The state then takes appropriate or inappropriate action. The two significant shortcomings of this approach are that the snapshot database is old (“stale”) the moment it is created and the compare criteria is commonly in error.

Stale data refers to data in a database that is inaccurate because of a change in the data after the database is created which the database inaccurately reflects. Since states require a new database snapshot periodically (i.e. once per quarter), there is an opportunity for the vehicle owner to cancel the policy after the snapshot is created and thus is able to drive around uninsured. Conversely, a vehicle owner that purchases a policy the day following the creation of the database snapshot will be identified as uninsured while in fact is legally insured. The database snapshot does not accurately reflect the true insured status with the Insurance Company.

An additional shortcoming of the database compare method is the compare criteria are frequently in error. The most common error involves the Vehicle Identification Number (VIN) being utilized as the key for the database record lookup. Often, the VIN is entered improperly in one of the databases resulting in a failed compare and subsequent action by the state.

A second method involves all insurance companies sending policy status updates to a centralized database system. The centralized database is then queried to determine if a motor vehicle is insured. This method also suffers from the two previously mentioned shortcomings. Since each insurance company must send the status change of a vehicle owner to the common centralized database, there is ample opportunity to miss an update resulting in data in the centralized database not reflecting the true status of the vehicle owner thus stale data. And since the vehicle entry in the state registered vehicle database is created separately from the vehicle entry in the insurance company database which is created separately from the vehicle entry in the common centralized database, there are more opportunities to have mismatched database query information.

### SUMMARY OF THE INVENTION

This system and method of instant Automotive Liability Insurance verification specifically overcomes the shortcomings of the database compare methods (either book of business compare method or common centralized database) and current paper card based vehicle insurance identification issued by insurance companies and carried by motorists across the nation. In one approach with this system, a new insurance card is issued to each vehicle. The new card includes bar-coded information, or magnetic encoded information, is a Radio Frequency Identification (RFID) transponder with stored information or other comparable data. This information includes the unique vehicle/policy identifier (PI—also referred to herein as the data query key) assigned by each insurance company (i.e. an assigned or random number or string, the Vehicle Identification Number (VIN) and/or license plate number and/or the insured's name or some combination of any of these items), an optional translation control code (TCC) and a home Identifier (HID). The optional translation control code and home identifier are collectively referred to as the Homing Tag. The translation control code, home identifier and unique vehicle/policy ID can be combined into a single one dimension encoding, single multidimensional encoding or may be one or more separate encoding with delimiters. The information may be encoded in a machine-readable encoding such as a standard barcode to minimize the impact to existing systems. One embodiment may have two barcodes, one may include the Insurance Company assigned vehicle policy identifier (PI) and the second barcode may include an identifier to uniquely identify a specific Insurance Company (Homing TAG).

The system and method is utilized when a barcode scanner is utilized to read the Homing Tag and PI, read the Homing Tag and License Plate number, read the License Plate number, or some other pre-defined letter/number sequence, or is initiated on a computer after a keyboard “Enter” key is pressed following a barcode scan or manual entry of the encoded information or is initiated by RF scan of the RFID transponder. A software routine extracts and applies the Homing tag data to a translation/routing table which returns the network (Internet) address or Web Service Signature which includes the network address of the specific insurance company to send the electronic information request. The software routine creates a message including a message type tag, requester ID and address, an optional security access code, home identifier, and the PI and sends it to the insurance company across the Internet. Software located at the insurance company (the other end of the internet link) receives the Internet message, decodes that it is an authorized insurance status request, performs a local database lookup for the insurance status, builds a response message with the appropriate information (owner or responsible party, license plate number, vehicle model and type, VIN, and insurance status for example: active, canceled, or non-existent) and sends the response message via the Internet back to the original requester using the received requester address. The software that originated the request receives the message and displays the information in a custom format.

The Program initiating and/or handling the data exchange (this invention) and the Program responding to the data exchange (at each insurance company or other remote database) are tightly or loosely coupled using any of currently available methods including proprietary socket based, Web Services, Remote Method Invocation, etc. and the Programs communicate using proprietary and/or standard message formatting such as binary, HTTP, XML, JMS, etc.

As part of this system and method for enforcement of mandated insurance, a mobile enforcement capability is provided allowing law enforcement agencies with Internet capable cellular phone or other wireless device (i.e. wireless Palm Pilot, laptop, etc.) utilizing stored program control and a built in camera or other barcode scanning means to perform the same functions as a computer with a barcode scanner. Software exists today to convert a still image of barcodes to a standard barcode scan output. In this case, the image capture of the camera initiates the information request and the result is displayed on the wireless device.

In the embodiment, the system and method for mobile enforcement includes an Application Programming Interface (API) which allows a third party software company (specifically, the company or state agency which created/supports the police cruiser based vehicle registration query system) to perform an insurance verification information request. This system and method optionally allows a Homing Tag be displayed on the license plate or other visible location on the vehicle. The homing tag would be a sticker with, for example, three characters (letters and numbers) applied to the license plate or to the vehicle in a visible location. The officer today enters the license plate number into the in-cruiser system. The officer will optionally take the additional step of entering the Homing Tag information. The in-cruiser system using it's stored program control will provide the License plate number to the API or will combine the License plate number and the Homing Tag information and provide it to the API. The API itself is a stored program control and will perform the information request and return the result to the fixed or hand held terminal in the cruiser where it is displayed or audibly presented to the officer. In an alternate embodiment, as shown in FIG. 6, the routing key is stored as field in the vehicle registration database. In an alternate embodiment, as shown in FIG. 8, the routing key is obtained from a local translation table (6700) using only the vehicle license plate number (TAG), VIN, or other unique value as the entry index. In an alternate embodiment, as shown in FIG. 8, the actual insurance status is obtained from a local table (6700) using only the vehicle license plate number (TAG), VIN, or other unique value as the entry index.

The user subsystem (100) includes supplemental applications that are an extension specific to insurance verification. One such application works in concert with the vehicle registration database via the API to randomly query insurance companies against the vehicle registration database. The vehicle VIN, license plate number, or other unique identifier value obtained from vehicle record contained within the state vehicle registration database is utilized to obtain the routing key from the local translation table 6700. Over some predetermined time, based on the number of queries per hour the system will support, the entire vehicle registration database can be sequenced through and queries initiated for each vehicle entry in the registration database. A second supplemental program in the administration and control subsystem calculates the percentage of uninsured motorists based on the number of uninsured responses divided by the total number of queries or based upon the total number of registered vehicles.

The system and method should include the method described previously which includes a transaction across the internet initiated by a bar code scan, magnetic stripe scan, retina/fingerprint scan or RFID tag scan, and distributed routing tables or a centralized routing table to allow multiple companies to share the same communications infrastructure for what is effectively a distributed database system where the database is distributed among differing companies or state and federal agencies.

When insurance companies are comfortable providing information to a common database, the Homing Tag per vehicle can be eliminated in lieu of a database (local translation table 6700) containing the routing information so that the mobile enforcement capability is only required to enter the license plate number, VIN, or other unique vehicle identifier. The license plate number, VIN, or unique identifier is used as an index into the stated database to return either the Homing Tag or can contain the actual status of insurance. The following additional variations are included within the scope of this invention:
a) The Internet connection at either or both ends can be a wireless connection or a Local Area Network (LAN) or Virtual Private Network (VPN).
b) Note that this same method and system works with an RFID tag and RFID tag reader replacing the barcode and scanner respectively and also a magnetic card and magnetic card reader replacing the barcode and scanner respectively or smart card and smart card reader replacing the barcode and scanner respectively.
c) A variation on the system is to have all initiations go to a single centralized lookup table (as opposed to the distributed method previously described).

The following goes together to form a system and method to automate and assist the proper agencies, law enforcement, and other personnel in the immediate verification of information contained at one or more of many remote locations. This system preferably utilizes the Internet as a wide area network to connect corporations or individual users with disparate computer systems or otherwise non-connected competing companies or Federal, State, and Local Governmental agencies in a manner such that specific information can be retrieved without the use of a common collective database or singular routing hub. A singular routing hub is not excluded however it would limit the throughput of the system and provide a single point of surveillance thus is not the preferred embodiment. The system could also be implemented over a private Local Area Network, Wide Area Network, or Virtual Private Network as the communication system interconnectivity. The system is a closed system in that only authorized requests are processed (the requestor is authenticated). The system utilizes proprietary or public domain commands and responses and application specific user interfaces to interact with one of many existing information storage subsystems. In its initial implementation, the system will be used to verify, in real time, the current status of automobile liability insurance.

### BRIEF DESCRIPTION OF THE DRAWINGS

FIG. 1 is an illustration of high-level overview of the system.

FIG. 2 is an illustration of the User Subsystem (US) used in one embodiment of the present invention. There are N (one or more, no specified limit) User Subsystems utilized in the system however only one is shown for illustration purposes.

FIG. 3 is an illustration of the Data Server Subsystem (DSS) of the present invention. There are N Data Server Subsystems utilized in the system however only one is shown for description.

FIG. 4 is an illustration of the Control and Maintenance (C&M) Subsystem of the present invention. There is only 1 Control and Maintenance Subsystem utilized in the system however the system does not preclude the use of more than one Control and Maintenance Subsystem for redundancy purposes of Administration of the overall system or separation of system Administration on a per state basis.

FIG. 5 is an illustration of the various input devices that are connected to the User Subsystem in various configurations.

FIG. 6 is an illustration of the Insurance Compliance System showing the basic configuration.

FIG. 7 is an illustration of the Insurance Compliance System showing another configuration.

FIG. 8 is an illustration of the User Subsystem (US) API used with the embodiments of the present invention for transactional activity (machine to machine). There are N (one or more, no specified limit) User Subsystems utilized in the system however only one is shown for description;

FIG. 9 illustrates the steps for VIN verification, license plate verification and optional common data correction between the state registered vehicle database and the insurance company;

FIG. 10 illustrates a series of steps to perform an expired policy check against the translation table entries;

FIG. 11 illustrates the series of steps of fixed location insurance verification;

FIG. 12 illustrates the sequence of steps of the vehicle registration database application;

FIG. 13 illustrates the sequence of steps for mobile enforcement insurance verification.

### DETAILED DESCRIPTION

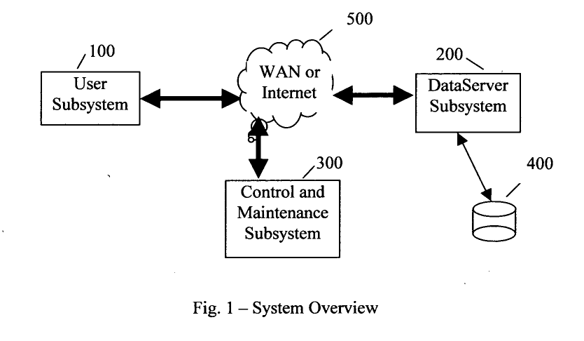

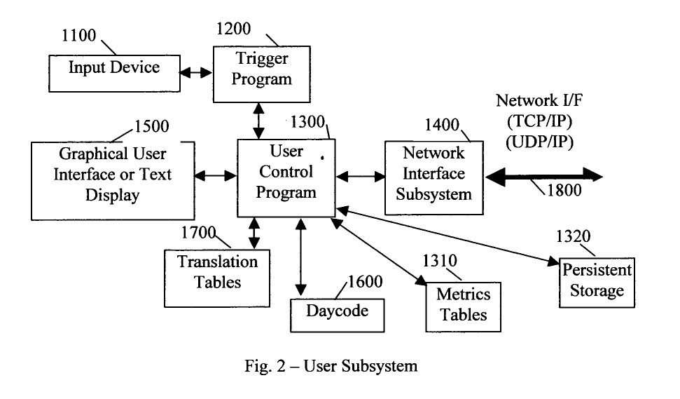

Referring to FIG. 1, the system is viewed as having at least three major components: one or more User Subsystems (100, multiple), one or more Data Server Subsystems (DSS, 200, multiple), and one or more Control and Maintenance Subsystems (300, one or more for redundancy) all interconnected and communicating with each other via a network (500) (a WAN, the Internet, etc.). The DSS contains the Database (400). The three subsystems are further viewed in FIGS. 2, 3, and 4 and are described in detail as follows.

Referring to FIG. 2, the User Subsystem includes of a input device (1100, barcode scanner, magnetic stripe reader, or RFID reader), a trigger program (1200), a User Control Program (UCP) (1300), a metrics table (1310), Persistent Storage (1320), a Network Interface Subsystem (NIS) (1400), a Graphical User Interface (GUI) or text display (1500), a Daycode table (1600), translation tables (1700), and a Network Interface (1800). Note that the User Subsystem can utilize a wireless interface to the Internet (i.e. cellular phone or Personal Digital Assistant, laptop with wireless modem, etc.) to provide a non-tethered, remote information verification system.

The barcode scanner will scan an insurance card containing the Homing Tag (HT) and Data Query Key (Vehicle Identification Number (VIN), license plate number, or other unique policy identification field) (collectively referred to as trigger data). The Homing Tag includes the combination of the optional translation control code (TCC) and the Homing ID (HID). The TCC identifies the translation method to be applied to the HID (don't translate or translate with specific table). The HID is either a direct routing address or is a key into a translation table including the routing address. The trigger data will be parsed by the trigger program (1200) and will be input to the User Control Program (UCP, 1300). The User Control Program will evaluate the TCC to determine if the HID is absolute or should be translated. If the TCC indicates to not translate (the HID is absolute), it is used as the network address directly for the data query. If the TCC indicates a non-absolute HID, the TCC indicates which translation table (1700) to utilize and the HID is translated into the network address. The network address contained in the translation table is either the Network Domain Name of the specific Data Server Subsystem, the Web Service signature of the Insurance company web service, or the absolute network address and port of the required form (i.e. nnn.nnn.nnn.nnn:port as specified by Internet Protocol) utilized to send the query or build the Web Service signature.

The User Control Program creates a network data query using the HID, the user subsystem identifier (UID), User Network Address, the Daycode (an optional security feature), the Translation Table ID, and the data key (unique vehicle or policy identifier—i.e. the VIN or license plate number or a unique insurance company assigned policy or vehicle identifier) and passes the query to the Network Interface Subsystem (NIS, 1400) for network transport. The NIS provides a standard UDP/IP and TCP/IP interface to the network using the HID based network address as the destination for the query. The destination is a Data Server Subsystem. A timer is started when the query is sent and allowing up to N queries where N is a variable to be initiated again if a response is not received within a preset time.

A local verification table is also optionally maintained on the system for self-insured individuals and for small insurance companies which do not maintain their own database. The table is maintained by the Control and Maintenance Subsystem (300). In the specific case of the local verification table, the HID indicates the local table is to be utilized and a verification of insurance is performed by a lookup into the local table using the VIN or license place number as the lookup key. The local table lookup simulates a Data Server Subsystem. The resultant insurance status contained within the local table is returned to the User Control program.

The User Control program receives network query responses from the Data Server Subsystem (DSS) that received the query. The timer associated with the query is cancelled. The insurance company assigned policy identifier is used as the data query key and the VIN, license plate of the vehicle, and/or common unique identifier (common to the DSS and the state vehicle registration record) is returned from the Insurance Company in the response. The returned VIN, license plate number and/or common unique identifier is then compared against the VIN, license plate number and/or common unique identifier contained within the vehicle registration database. If the value returned matches that stored in the vehicle registration database, the response is considered valid for that vehicle and the insurance status is displayed in a predetermined application specific format. A common identifier is included in both the vehicle registration database (which provides the common identifier to the User Control Program) and the insurance company database (the Data Server Subsystem) as a compare value to determine attempted fraud. If the comparison of the common identifier fails (either direct compare fails or a pattern match of less than 80 percent of the characters, for example), then the query was not valid for that vehicle. This fraud detection method is utilized to prevent a Query Key/Insurance Company combination for a valid insurance policy for one vehicle from being utilized for one or more vehicles for which the policy was not written. A difference exists in using the VIN, license place number or unique identifier as the query key (no fraud prevention) vs. using the VIN, license place number or unique identifier as a compare value (using something else as the query key and using the VIN, license plate number, or unique identifier compare as a fraud prevention method).

The User Subsystem receives periodically, for example at least once per day, a Daycode from the Control and Maintenance Subsystem (CMS) during the authentication process. The Daycode is the daily authorization code and improves the efficiency of the overall system by performing authorizations once per day. The Daycode is optionally included in each query to the DSS as an optional per transaction authentication method.

The User Control Program (UCP) contained within the User Subsystem provides local update capability of the Translation Table entries via interaction across the Network with the Control and Maintenance Subsystem (CMS). The Translation Tables entries are added, deleted, or changed. The entire table can be replaced by the CMS. The Translation Tables are used by the User Subsystems to locate and access the Data Server Subsystems.

Additionally, the UCP initiates a whole table update query if no table exists or the table becomes stale (contains old or otherwise incorrect routing entries). The UCP first tries to access the CMS. If a data query is made to a Data Server Subsystem and that specific Data Server Subsystem determines that the table is stale (via the table ID sent in the data query), the Data Server Subsystem will initiate a Translation Table update with the User Subsystem.

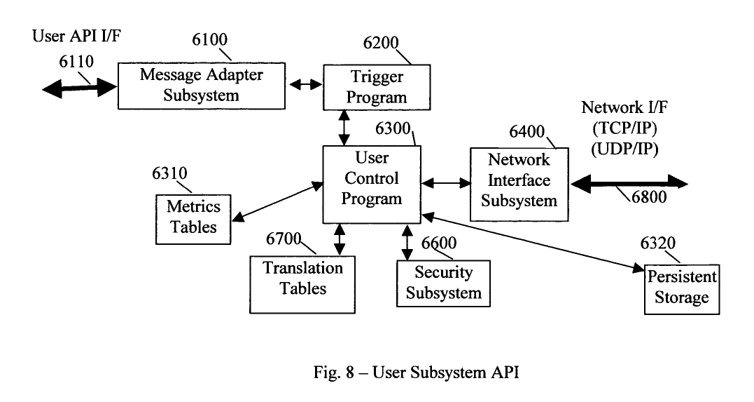

Referring to FIG. 8, the User Subsystem API includes a interface (6110, TCP/IP, UDP, proprietary, Ethernet, serial, X.25, wireless, as examples), a message adapter program (6100), a trigger program (6200), a User Control Program (UCP) (6300), a metrics table (6310), Persistent Storage (6320), a Network Interface Subsystem (NIS) (6400), a Graphical User Interface (GUI) or text display (6500), a Daycode table (6600), a translation table (6700) including a plurality of translation tables, and a Network Interface (6800). Note that the User Subsystem API can utilize a wireless interface (i.e. cellular phone or Personal Digital Assistant, laptop with wireless modem, etc.) to the Internet (6800) or a wireless interface (6210) to the trigger program (6200) to provide a non-tethered, remote information verification system.

An external computer system provides a data packet to the User API interface (6110). The data packet should include any formatted message containing the Data Key (Vehicle Identification Number (VIN) or license plate number, or unique insurance company assigned key such as the insured policy number) and optionally a Homing Tag (HT) (collectively referred to as trigger data). These are collectively known as an identifier of the vehicle or policy. The data packet will also optionally contain a unique user assigned packet ID to allow the sender to correlate the system response to their original request.

The Homing Tag includes of the combination of the optional translation control code (TCC) and the Homing ID (HID). The TCC identifies the translation method to be applied to the HID (don't translate, translate with specific table). The HID is either a direct routing address or is a key into a translation table.

The data packet is converted by the message adapter program (6100) to a standard format required by the user control program (6300). After conversion to the standard format by the adapter (6100), the data packet is presented to the trigger program (6200). The trigger program initiates the transaction and routing processing. The standard formatted trigger data will be parsed by the trigger program (6200) and is input to the User Control Program (UCP, 6300). The User Control Program evaluates the TCC to determine if the HID is absolute or should be translated. If the TCC indicates to not translate (the HID is absolute), it is used as the network address directly for the data query. If the TCC indicates a non-absolute HID, the TCC indicates which translation table (6700) or local insurance table (6700) to utilize and the HID is translated into the network address or extracts the local insurance status.

In the case of insurance verification where only a license plate number (TAG), VIN or unique identifier is entered, the TCC specifies the license plate number, VIN or unique identifier to be utilized as the key into the translation table (6700), specifically, the license plate TAG, VIN or unique identifier to HT translation table. The HT contained in the translation table is the homing tag of the specific insurance company or the local table identifier containing insurance status. With the HT, the user control program then performs a second translation of HID to insurance status or network address as stated previously of either the Network Domain Name and web service address of the specific Data Server Subsystem or the absolute network address of the required form (i.e. nnn.nnn.nnn.nnn:port and web service specification).

The User Control Program creates a network data query using the HID, the user subsystem identifier (UID), User Network Address, the Daycode, the Translation Table ID, and the data key (i.e. VIN or license plate number) and passes the query to the Network Interface Subsystem (NIS, 6400) for network transport. The NIS provides a standard UDP/IP and TCP/IP interface to the network using the HID based network address as the destination for the query. The destination is a Data Server Subsystem determined by the routing lookup (first by translation of the TAG, VIN or unique identifier to HT, then by translation of the HT to HID). A timer is started when the query is sent and allowing up to N queries (N is programmable) to be initiated again if a response is not received within a preset time.

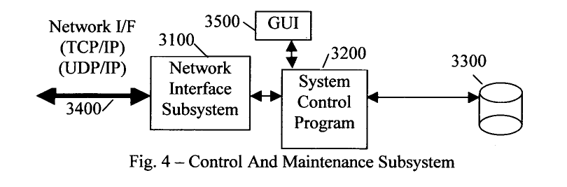

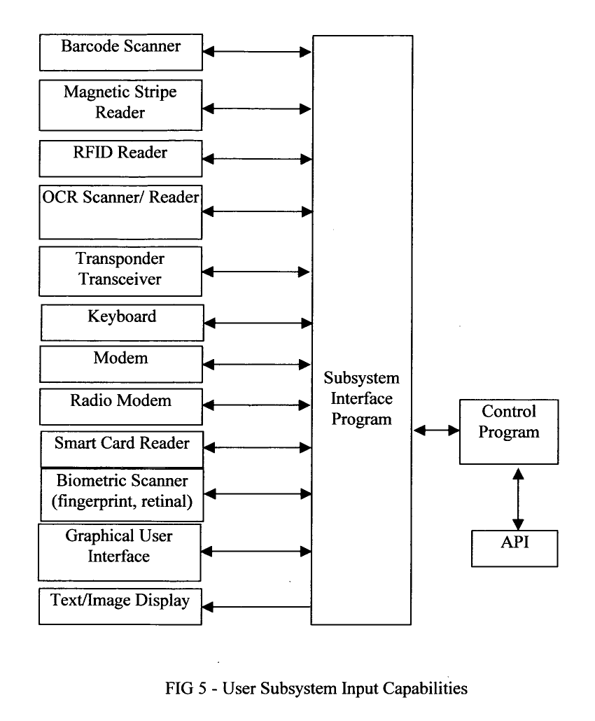

The User Control Program (6300) collects counts of queries including initiations and responses to each data server subsystem and logs the counts into the Metrics Table (6310). Stored values are kept including a count of the number of queries to an endpoint, a count of the number of valid insurance responses from an endpoint, a count of the number of invalid insurance responses from an endpoint, the accumulated query time to an endpoint, and the largest and smallest time of query to an endpoint. The metrics table collects data using programmable intervals (i.e. 30 minutes), and writes the data to Persistent Storage (6320) for later extraction by the Control and Maintenance Subsystem (FIG. 4). After writing the metric data to persistent storage, the table is zeroed for the new collection period. Note that as an alternative, two tables could be utilized, one for collection and one for writing to persistent storage with the table being written to persistent storage zeroed out after the write activity and then toggled, with the table being used for collection at the end of the collection period. After transfer of the metrics data to the Control and Maintenance Subsystem, the average time to response of queries for the period and the uninsured motorist rate are processed within the Control and Maintenance Subsystem and the performance of each data subsystem is quantified with the following three metrics which are also written to the Metrics Table; average time to response, minimum time to response, maximum time to response. The insured motorist rate, as a percentage, is calculated as the total number of “insured” responses from all sources divided by the total number of successful query responses from all sources. The uninsured motorist rate, as a percentage, is calculated by subtracting the total number of “insured” responses from the total number of successful query responses from all sources, and dividing that number by the total number of successful query responses from all sources. The processed data is stored in persistent storage (2500) and may be extracted by transaction or GUI means.

The User Control program receives network query responses from the Data Server Subsystem that received the query. The timer associated with the query is cancelled. The data is passed back to the message adapter subsystem (6100) for conversion back to the User specific format and the User formatted response is transferred back to the User (6110).

The User Subsystem receives periodically, at least once per day, a Daycode from the Control and Maintenance Subsystem (CMS) during the authentication process. The Daycode is the daily authorization code and improves the efficiency of the overall system by performing authorization once per day. The Daycode is included in each query to the DSS as the per transaction authentication method.

The User Control Program contained within the User Subsystem provides local update capability of the Translation Table entries via interaction across the Network with the Control and Maintenance Subsystem. The Translation Tables entries are added, deleted, or changed. The entire table can be replaced by the CMS. The Translation Tables are used by the User Subsystems to locate and access the Data Server Subsystems.

Additionally, the UCP initiates a whole table update query if no table exists or the table becomes stale (contains old or otherwise incorrect entries). The UCP first tries to access the CMS. If a data query is made to a Data Server Subsystem and that specific Data Server Subsystem determines that the table is stale (via the table ID sent in the data query), the Data Server Subsystem will initiate a Translation Table update with the User Subsystem.

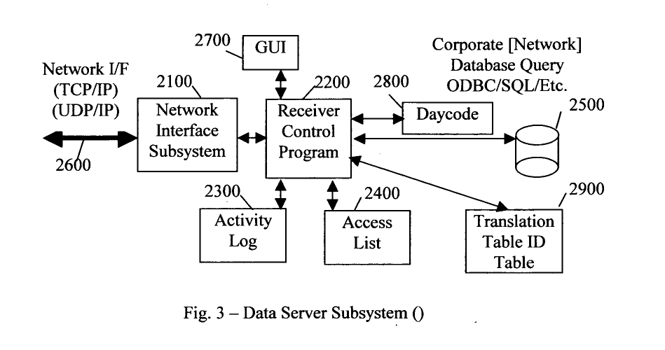

Referring to FIG. 3, the Data Server Subsystem includes a Network Interface (2600), a Network Interface Subsystem (2100), a Receiver Control program (2200), a GUI (2700), an activity log (2300), an access list (2400), a database or data file (2500), a Daycode table (2800), and a translation table ID table (2900).

The Data Server Subsystem (DSS) receives a query from a User Subsystem via the Network Interface (2600) to the Network Interface Subsystem (2100). The NIS provides a secure transaction capability such as SSL. The user query is parsed by the Receiver Control Program (RCP, 2200) and the received Daycode is verified against the daycode (2800) for validation of user access. If the Daycode is invalid, the UID, Network address, and time received are logged in the activity log (2300). In addition to, or in lieu of, the Daycode validation, the received UID is verified against the access list (2400). The Daycode is unique to the system, calculated at the start of the day, and is sent to each User Subsystem upon authentication once per day by the user to the CMS.

After validation of the source of the query, the Receiver Control Program creates a database query using the required database query language for the location (ODBC, SQL, etc.) and performs the query to the database or data file (2500).

A Graphical User Interface (GUI, 2700) is available to view the activity log, modify the access list, and update the Daycode manually.

Additionally, the received user's Translation Table ID is checked to determine if the translation table is stale. If the received table ID does not match the value contained in the translation table, the User Subsystem translation table is considered stale (old or containing expired data), the Data Server Subsystem, if enabled to do so, initiates a Translation Table update to that specific User or sends a Table update notification to the CMS so that the CMS can initiate the Table Update.

The response to the database query is constructed by the Receiver Control program into a response to the network address of the original requester. The response, addressed to the network address of the UID, contains optionally any combination of the VIN, license plate number, make, model, year of auto, query operation status, and expiration date of the insurance policy or an insurance valid flag of “current”, “expired”, or “cancelled”. If the database query results in a failure to find the information, the validity flag of “not found” is returned in the response query. The query operation status indicates the success of DSS database lookup. The response to the query is logged in the activity log.

If a Daycode was not received or was incorrect by the sender, the DSS will optionally validate the UID against the access list and after validation of the UID, the current Daycode is sent to the user for subsequent queries (faster validation).

The Data Server Subsystem contains local terminal access via a custom GUI for the purpose of local table viewing and updates. The GUI provides access to the access list, query log, Receiver ID, all tables, and the Daycode.

The Data Server and User Subsystems accept requests from the CMS for the query logs. The Query logs are transferred to the CMS and upon receipt acknowledge of the transfer, and are initialized to zero entries. The query log contains failed validations for security uses and optionally database results for system metrics capability. As an option, the Query log can be processed for metrics data locally if the insurance companies do not wish to have the non-failed queries collected external to their company.

The Data Server Subsystem accepts Access List updates from the CMS. The updates are individual entry updates or entire list updates. The update is accepted after the CMS identification is authenticated.

The Data Server Subsystem can initiate an update to the translation tables (1700, 6700) within the User Subsystem or Control and Maintenance Subsystem to update the route for a specified table entry. The DSS initiates a table update to the CMS by sending a message to the CMS containing the update type identifier (route or insured entry) and one or more of the following data: license plate number and/or VIN number, unique identifier or policy number, the time to policy expire value, IP address and port, web service signature and the insurance company HID. The message is sent utilizing the NIS capabilities. The CMS updates the specified table entry and sends a response message indicating success or failure of the table update back to the initiating DSS.

There are two translation tables of primary interest utilizing updates from the DSS to the CMS. The HID to route translation table, and the License Plate Number (TAG), VIN or unique identifier to HID translation table. All updates and acknowledgements are accomplished via the NIS using any of the prescribed methods (i.e. TCP/IP, UDP, proprietary messaging or web service, etc.). Each table update is acknowledged in that a response is sent from the User Subsystem or Control and Maintenance Subsystem to the specific insurance company DSS that the table update was accepted.

All updates to the translation table containing HID to route translation entries are immediate after receipt of the new route (i.e. network address or web service signature) from the insurance company matching the HID. Route update requests where the sender of the update does not match the HID of the table entry are rejected. The update contains the HID of the requestor and the new route.

Updates to the translation table containing TAG/VIN/Unique ID to HID translation entries are either immediate or buffered depending on the data contained in the update. The update includes the license plate number and/or VIN number, unique identifier or policy number, a time to policy expire value, the insurance company HID. A value of nonzero for a policy expire value constitutes notification of a policy update while value of zero for a policy expire value constitutes notification of a cancelled policy by that insurance company. If a translation table update is received but no existing table entry is located for update, a new table entry is created. Translation table entry creations and updates are immediately applied to the TAG/VIN/unique ID to HID translation table and propagated to the User Subsystems. Policy deletions (initiated by a translation table update with a policy expire value of zero) are buffered for a programmable amount of time.

TAG/VIN to HID translation table updates are buffered within the CMS using two watch tables in persistent storage 3300, one watch table for translation table entry creations (new entry watch table) and one watch table for translation table entry deletions (expired/deleted entry watch table). Each entry of each of the two watch tables contains a programmable aging value used to age records (the buffering). This buffering allows for an individual to move from one insurance company (canceling a policy) to another (creating a policy) without an entry being created on the expired policy list file which is reported to state agencies for further action.

When a policy cancellation is received from an insurance company (TAG/VIN/Unique ID to HID translation table entry update with policy expire value of zero), an entry is created in the expired entry watch table with an initial aging value of nonzero (some programmable value). Each night or other appropriate time, a program on the CMS scans the list of entries in the expired entry watch table and compares each entry against entries in the new route watch table. If a matching entry is found in the new route watch table (the TAG, VIN or Unique ID matches), the TAG/VIN/unique ID to HID table entry is updated by updating the HID value. Then the expired watch table entry and new entry watch table entries are deleted. If no matching entry is found in the new entry watch table, the aging value of the expired entry is decremented. When the aging value of the expired entry reaches zero, the entry is moved to the expired policy list file. The expired policy list file is periodically reported to the state.

When a policy update or creation is received from an insurance company (TAG/VIN/Unique ID to HID translation table entry update with policy expire value of nonzero), an entry is created in the new policy entry table with an initial aging value of non zero (some programmable value) and a normal update to an existing translation table entry or the creation of a translation table entry occurs immediately. At the end of the scheduled scan of all expired translation table entries, the aging value of all new policy table entries is decremented. When the aging value of a new entry reaches zero, the entry is removed from the new entry watch table with no further action required.

Referring to FIG. 4, The Control and Maintenance Subsystem (CMS) includes a Network Interface (3400), a Network Interface Subsystem (3100), a System Control program (3200), a GUI (3500), and persistent storage (3300) containing one or more system tables.

The CMS provides User and Authentication methods for all DSS and User Subsystems. The CMS provides access list updates to the Data Server Subsystems and Daycode updates to all DSS and User Subsystems. The CMS also requests and receives the Query logs from the Data Server Subsystems. The CMS is also referred to as the Administrative Subsystem.

The CMS provides local update capability of the Receiver list entries. The Receiver list entries are added, deleted, or changed. The Receiver list is used to provide destinations to the CMS for propagating Access List updates. The receiver list is a superset of the Translation Table entries containing additional system security information. The Receiver List, as with all other tables maintained by the CMS, is maintained on the Storage Subsystem (3300). The CMS provides local update capability of the Translation Table entries utilizing a local Graphical User Interface or machine to machine transaction method (i.e. web service). The Translation Tables entries are added, deleted, or changed. The Translation Tables are used by the User Subsystems to locate and access the Data Server Subsystems or local table containing insurance status. As an option, after update of an individual table entry, the individual entry is propagated to all User Subsystems contained within the Receiver List, via the NIS. Optionally, the entire list is broadcast to all User Subsystems contained in the Receiver List.

The CMS provides local update capability of the access list entries. The access list entries are added, deleted, or changed. As an option, after update of an individual entry, the individual entry is propagated to all Data Server Subsystems contained within the Receiver List, via the network. Optionally, the entire list is broadcast to all Data Server Subsystems contained in the Receiver List.

The CMS periodically polls all User Subsystems and Data Server Subsystems for their Query logs. The Query logs are extracted and system metrics are created from the query data.

The CMS stores a user access list in the database (3300). A GUI is provided to add and delete users from the user access list. The login and password of the user subsystem are stored in the database. Users can also be marked as disallowed to explicitly deny access.

The CMS stores a DSS access list in the database (3300). A GUI is provided to add and delete DSS from the user access list. The login ID and password of the DSS are stored in the database.

The CMS contains a computer program that collects metrics from each User Subsystem and writes the data to persistent storage (3300). The computer program compares the metrics against pre-configured thresholds and provides a popup GUI (3500) to notify that the specific Data Subsystem is outside the pre-configured thresholds. Another GUI is provided to view the data in a user useful format.

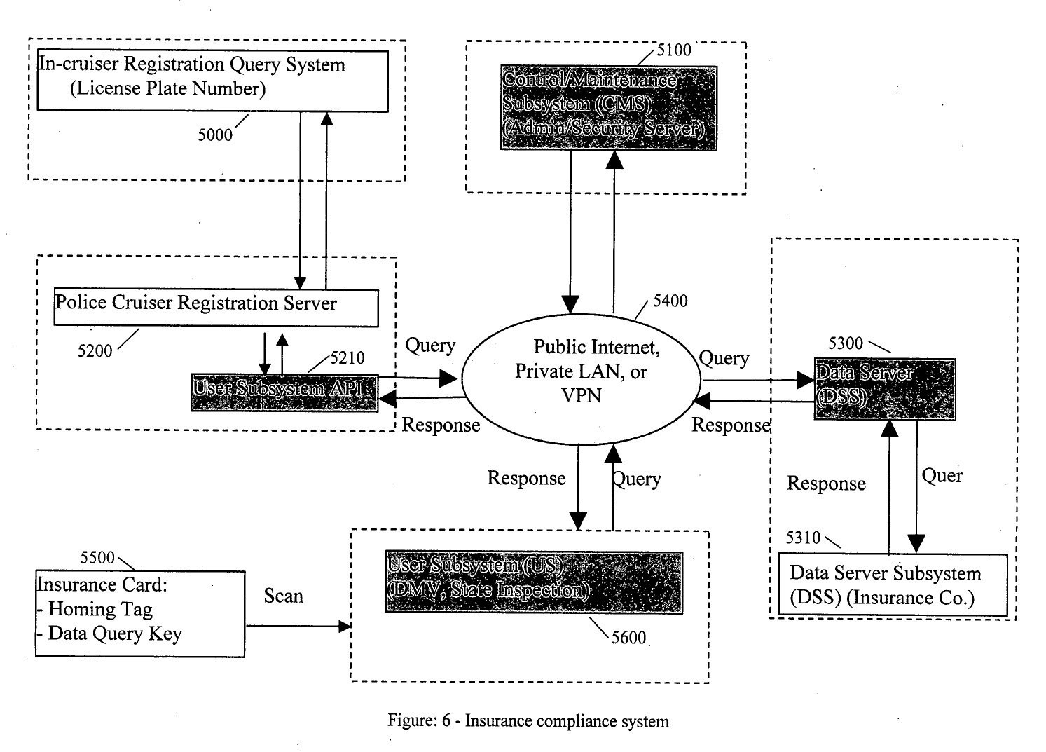

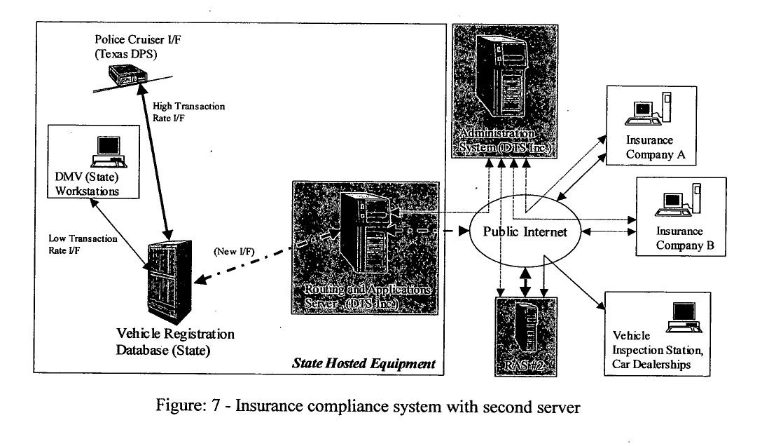

Referring to FIG. 6, in addition to specific user interfaces, an application-programming interface (API) (FIG. 6, 5210) is available to allow external or third party systems (5000, 5200) to perform queries into the system. The API is actually a collection of several APIs. The third party program (5000 and 5200) may collect the required information and provid it to the API for subsequent query and the result of the query is delivered to the third party program for presentation by the third party program. Or the 3^{rd} party system may be modified directly to perform the data query and display the result. The 3^{rd} party system would have to abide by all security and authentication requirements. The API has the appearance to the system of being a User Subsystem with all the same capabilities and functions including authentication. The User Subsystem API is described in more detail in FIG. 8.

An example of a third party system that will utilize this API would be the police cruiser based vehicle registration query system. APIs are provided for user authentication, interaction with the administration services function, and data query access. The existing in cruiser software will be modified to optionally collect the routing key (Homing Tag) in addition to the already entered vehicle license plate number or VIN. The optional routing key (Homing Tag) and license plate number (TAG) or VIN would be delivered to the API by the existing state based system which serves the police cruisers today with the vehicle registration data, which would then perform the translation and routing lookup and subsequent query. The returned query result would then be delivered to the third party software (modified through the use of the APIs to accept the query and result) where it would then be presented to the officer/requestor.

The user subsystem API contains stored program control (6300) to perform several operations specified in the following paragraphs.

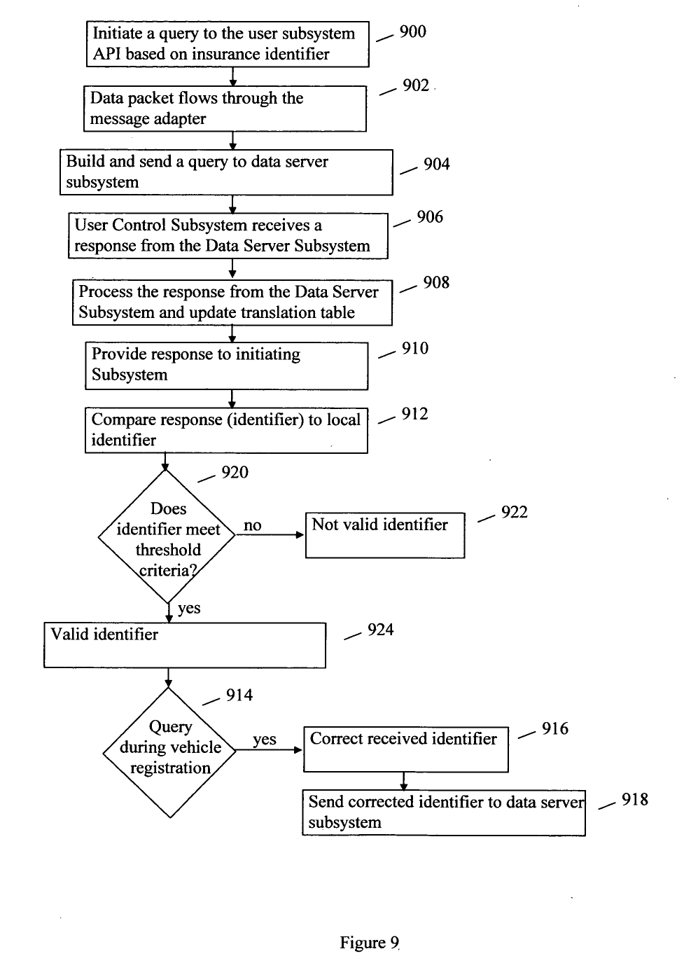

The user subsystem API contains stored program control (6300) to perform VIN verification, License plate verification, and optional correction between the State registered vehicle database and the insurance company containing the policy for the vehicle. FIG. 9 shows the steps as described below.
a. The initiating subsystem (i.e. Department of Motor Vehicles) initiates in step 900 a query to the User Subsystem API (6110) containing a combination of the License plate number, VIN, homing tag, or policy number, or some other pre-defined letter/number combination unique identifier to a specific insurance company on a per registered vehicle basis.
b. The data packet corresponding to the identifier flows in step 902 as previously described through the message adapter (6100) and trigger control program (6200).
c. The User Control Program (6300) builds and sends in step 904 a query to a Data Server Subsystem as previously described
d. The User Control Program (6300) receives in step 906 the response from the Data Server Subsystem containing the combination of the VIN, license plate number, policy number, and expiration date of the insured policy.
e. The User Control Program processes the response in step 908 from a Data Server Subsystem and updates the translation table (6700) entry for the specified license plate/VIN, or unique ID with the Insurance Company Homing ID and the policy expiration date.
f. The response is provided in step 910 to the initiating subsystem as previously described.
g. The initiating system compares in step 912 the received VIN and/or license plate number (TAG) and/or unique ID against the VIN and/or license plate number and/or unique ID stored in the vehicle registration database.
h. If the query was performed during vehicle registration in step 914, the VIN and/or license plate number and/or unique identifier is corrected by one of several means: the VIN, TAG and/or unique identifier is/are corrected in step 916 using manual intervention at the incorrect location or if the VIN or license plate number or unique identifier mismatch is less than some predefined number of characters (i.e. VIN is correct in all but one or two character positions, programmable) the initiating subsystem sends in step 918 a “data correction” message containing the correct VIN, TAG and/or unique identifier using the API to the data server subsystem (the insurance company) where the insurance company database is updated with the correct VIN and/or license plate number and/or unique identifier automatically, or the data correction message is received by the insurance company and queued or presented to a human for manual correction.
i. If the query was performed during a vehicle insurance verification (either on the road by a police officer or during the vehicle state inspection process), the VIN or unique identifier should match (for example meet some minimum predetermined threshold criteria in step 920 such as 80% character match) for the user subsystem to report that the insurance is valid in step 924. If the VIN or unique identifier compare fails, a “VIN/identifier mismatch” indicator is passed to the police officer in addition to the insurance not valid indicator in step 922.

One could substitute the vehicle license plate or a unique identifier in lieu of the VIN for record matching as fraud detection or a combination of the data or any other common piece of comparable data that exists in both databases (the vehicle registration database initiating the query and the database of the insurance company being queried).

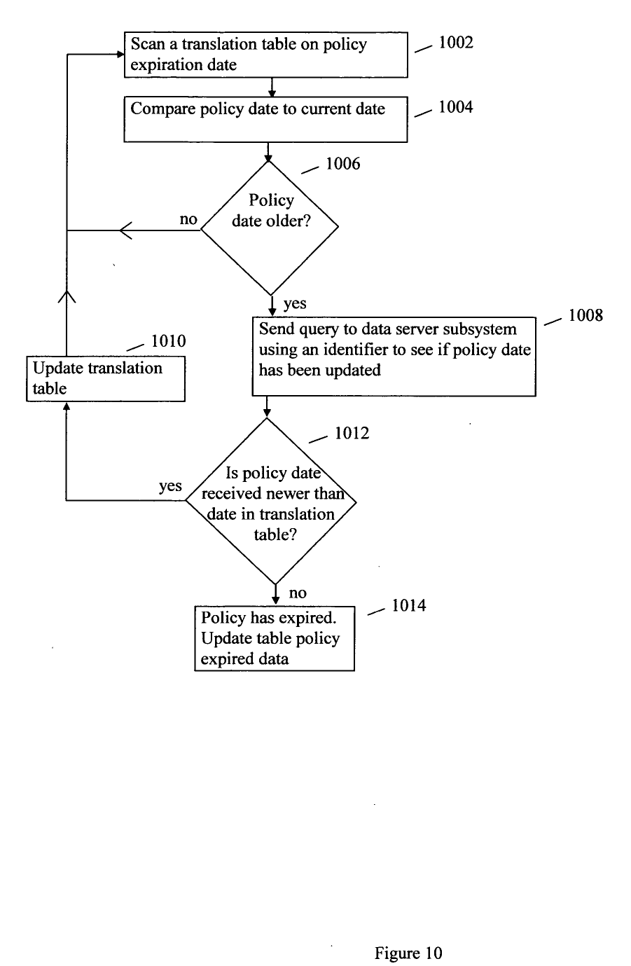

The user subsystem and control and maintenance subsystem contain stored program control (6300) to perform an expired policy check against the translation table entries. The translation table entries contain the vehicle license plate, VIN, unique identifier, Homing ID, routing address, and expiration date of the vehicle policy. The steps are shown in FIG. 10.
a. Periodically (i.e. nightly) the User Control Program (6300) or administration subsystem (300) scans in step 1002 the entire translation table and compares in step 1004 the policy expiration date to the system current date (i.e. today's date).
b. For each entry where the policy expiration date is earlier (older) in step 1006 than the current date, the User Control Program (6300) or administration subsystem (300) builds and sends a query in step 1008 to a Data Server Subsystem as previously described
c. The User Control Program (6300) or administration subsystem (300) receives the response from the Data Server Subsystem containing the VIN, license plate number, policy number, and expiration date of the insured policy.
d. If the policy date in the received response is later (newer) than the policy date in the translation table, the translation table policy expiration date is updated in step 1010.
e. If the policy date in the received response is earlier (older?) or equal to the policy date in step 1012 in the translation table, a policy expired entry is made into the expired policy list file contained in persistent storage (6320) or (3300) in step 1014.

The expired policy list file is extracted periodically by the Control and Maintenance Subsystem and is available for further action by the specific state required activity. The extraction produces a list of expired policies sorted by VIN or TAG.

The System and Method for Internet based Instant Information Verification System (IIVS) provides real time automobile liability insurance verification. All data requests preferably require an indirection by using a homing tag lookup into the translation table (XT) also referred to as a network address table (NAT). The homing tag should not be used for direct routing. The specific network addresses are considered a security issue and are a restricted element (guarded secret) of the system. If a homing tag could be utilized for direct request routing then someone could create a counterfeit card and have the request route to his or her counterfeit database, which would return a counterfeit valid response. The NAT in the user subsystem can only be updated and distributed by the administration function (CMS) thereby restricting update access to the routing capability. The distribution to end user segments is by secure connection after user validation.

Data requests received by the data servers are counted and measured against time resulting in queries per minute value. Data servers can maintain a local table of excluded users (access table with exclusion or “disallow” markings) attempting to perform more than N queries per minute. Any user, which performs more than N queries per minute, is added to the table or marked in the table as “disallowed” and a message is sent to the administration function with that User ID. The administration function will disallow system logins by that user. For each data request, the exclude table is optionally checked and if a user ID is present in that table, the user request is denied.

The system and method for instant automotive liability insurance verification allows a remote location to perform data requests to any specific insurance issuing insurance company. The data request results in a real time query into the insurance company maintained insurance database and returns a time stamped response indicating the current status of the vehicle insurance.

Referring to FIG. 6, the Insurance compliance System and method includes the insurance card (5500), the remote user subsystem (5600), the public Internet (5400), the DSS (5300) and the DSS database (5310), the CMS (5100) and the API interface to the police cruiser based registration verification system (5000 and 5200). The system initiates a query by 5600 performing a scan of 5500 or by a policeman entering the license tag or VIN and optionally the homing tag displayed on the vehicle into the police cruiser based registration verification query system (5000) which performs it's query to the registration server (5200) which utilizes the API (5210) to perform the insurance verification query.

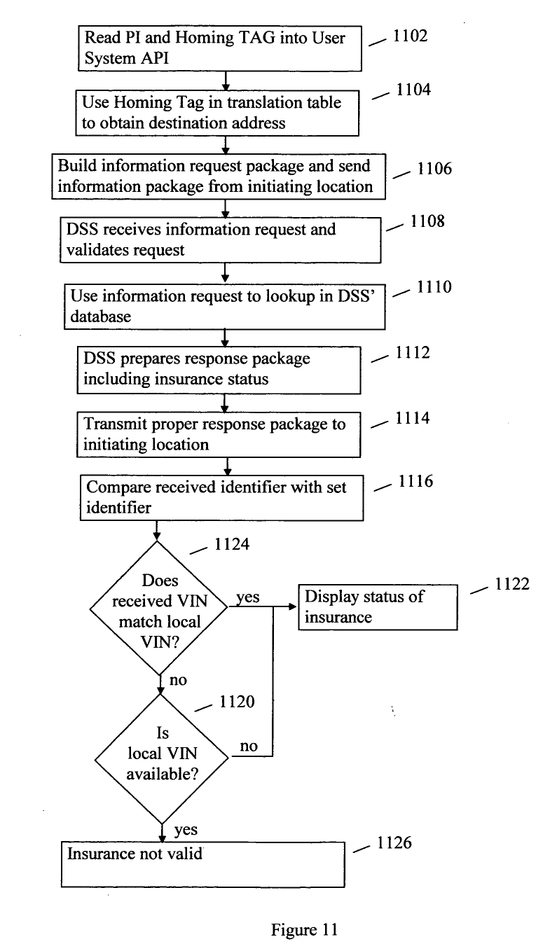

The present invention provides the following system and method of fixed location insurance verification in FIG. 11:
a. A paper proof of liability insurance card (5500) is provided to the vehicle owner (insured) as is done today however, the card includes a barcode based unique Insurance Company policy identifier (PI, also referred to as the data query key) and a barcode based unique Insurance Company Homing Tag or other suitable identifier. The barcode information can be a single barcode containing both items or can be encoded in multiple barcodes.
b. A barcode scanner (contained within 5600) is used to scan the PI and Homing Tag (encoded into one or more barcodes) or the user subsystem API is utilized to provide VIN, license plate number (TAG), Homing Tag, and PI in step 1102.
c. Under stored program control the Homing Tag is used as a lookup key in a locally stored translation table. The result of the lookup is the destination network address (IP address and port or complete web service signature) in step 1104 of the stored program control located at the specific data server subsystem (at the insurance company). Under stored program control, the VIN is extracted from the vehicle registration database and is stored locally for comparison in step [l].
d. An information request package is built in step 1106 containing the Daycode, translation table ID, the sender ID and password, sender network address, and the unique policy identifier (PI) required by the insurance company. The data are optionally encrypted.
e. The information package (query) is sent from the initiating location to the specified destination network address (i.e. via UDP message, TCP message, web service invocation or remote method invocation call).
f. At the destination (DSS, the insurance company), stored program control receives in step 1108 the information request and validates the security Daycode and/or username and password.
g. If the security Daycode and/or username are/is valid, the unique policy identifier, VIN, license plate number or unique policy identifier is used as a lookup key in step 1110 into the insurance company database.
h. The insurance company database is queried locally by the Data Server Subsystem stored program control at the insurance company.
i. The result of the insurance company database lookup (insurance current, expired, cancelled, not found) is constructed into a response package in step 1112. The response package includes the VIN or unique insurance company assigned value, the insurance status and optionally one or more of the following: the license plate number, security Daycode, the Sender ID, the date and time, query operation status, and the insurance policy expiration date.
j. The response package is transmitted in step 1114 across the network to the user network address at the initiating location.
k. The package is received by the stored program control at the initiating location and the received Sender ID is compared in step 1116 to the real Sender ID.
l. If the Sender IDs match, the returned VIN or unique ID supplied in the response by the insurance company is compared to the locally stored VIN or unique ID in step 1124. The locally stored VIN or insurance company assigned unique ID is extracted from the vehicle registration database or was provided by the API.
m. If a locally stored VIN was available in step 1120 and if a compare of the received and locally stored VIN values results in a match in step 1124, the insurance status (insurance valid, cancelled, expired, not found) is displayed in step 1122.
n. If a locally stored VIN was available and if the VIN values do not match, the status displayed is “VIN xxx (from vehicle registration database) does not match VIN yyy (received from Insurance Company). Insurance status is displayed as not valid” in step 1126.
o. If a locally stored VIN was not available, no VIN compare is attempted and the insurance status (insurance valid, cancelled, expired, not found) is displayed.

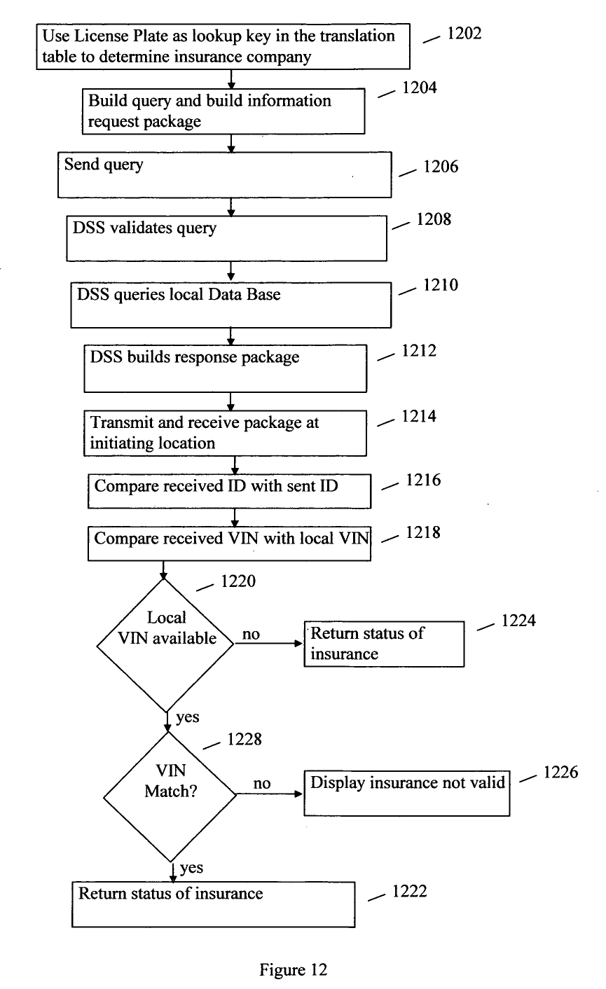

As an extension to the method of a single verification just presented (beginning [73]), the user subsystem will accept query initiations from the API (6110) and provides query responses to the system initiating queries (i.e. state vehicle registration database control program) using the API. This method allows interaction with a state vehicle registration database for the purpose of ascertaining if 100% of the vehicles in the vehicle registration database contain a corresponding insurance policy. This invention works in concert with an application running on the system containing the, or a copy of, vehicle registration database. The vehicle registration database application sequences through the entire vehicle registration database and initiates a query, via the API (6110), for each vehicle entry in the database. The sequence of steps is as follows in FIG. 12:
a. Each query contains the vehicle license plate number and VIN as extracted from the vehicle registration database. The User Control program (6300) uses the license plate as a lookup key in the translation table (6700) returning the route key (homing tag) in step 1202 for the insurance company having the policy on that vehicle and optionally the insurance company assigned policy key while the VIN and license plate are stored locally for comparison in step [l].
b. The insurance route key (homing tag) is then used as a lookup key in the translation table (6700) to determine the insurance company route for that vehicle.
c. A query is built containing the license plate or insurance company assigned policy key and sent to the route specified in the previous step.
d. An information request package is built in step 1204 containing the Daycode, translation table ID, the sender ID and sender network address, and the license plate number, VIN or unique policy identifier (PI) required by the insurance company.
e. The information package (query) is sent in step 1206 from the initiating location to the specified destination network address (i.e. via UDP message, TCP message, web service or remote method invocation call).
f. At the destination (DSS, the insurance company), stored program control receives the information request and validates in step 1208 the security Daycode and/or username.
g. If the security Daycode and/or username are/is valid, the unique policy identifier, VIN or license plate number is used as a lookup key into the insurance company database.
h. The insurance company database is queried locally in step 1210 by the Data Server Subsystem stored program control at the insurance company.
i. The result of the insurance company database lookup (insurance current, expired, cancelled, not found) is constructed into a response package in step 1212. The response package includes the VIN and the insurance status and one or more of the following: the license plate number, security Daycode, the Sender ID, the date and time, and the insurance policy expiration date.
j. The response package is transmitted across the network to the user network address at the initiating location.
k. The package is received in step 1214 by the stored program control at the initiating location and the received Sender ID is compared in step 1216 to the real Sender ID.
l. If the Sender IDs match, the returned VIN supplied in the response by the insurance company is compared to the locally stored VIN. The locally stored VIN is extracted from the vehicle registration database or was provided by the API.
m. If a locally stored VIN was available and if a compare of the received and locally stored VIN values in step 1218 results in a match, the insurance status (insurance valid, cancelled, expired, not found) is returned in step 1222 the API as a unique agreed upon code (i.e. ‘1’ for valid, ‘2’ for canceled, “valid” or “cancelled”, etc.)
n. If a locally stored VIN was available in step 1220 and if the VIN values do not match, the status “VIN xxx (from vehicle registration database) does not match VIN yyy (received from Insurance Company) is displayed. Insurance not valid” is returned in the API as a unique agreed upon code (i.e. ‘8’, or “failed VIN” for VINs don't match) in step 1226.
o. If a locally stored VIN was not available, no VIN compare is attempted and the insurance status (insurance valid, cancelled, expired, not found) is returned in step 1224 in the API as a unique agreed upon code.

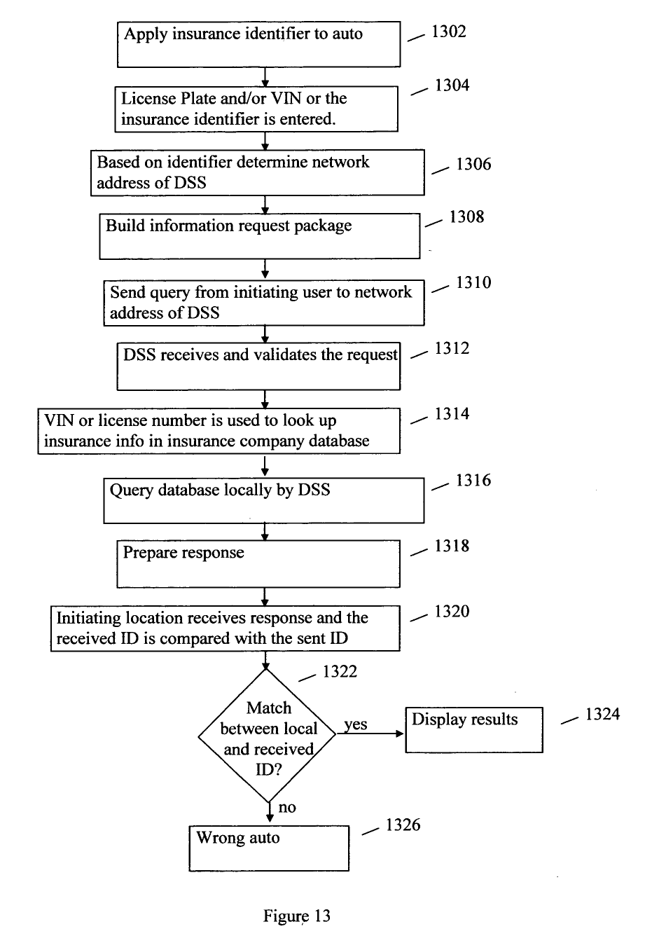

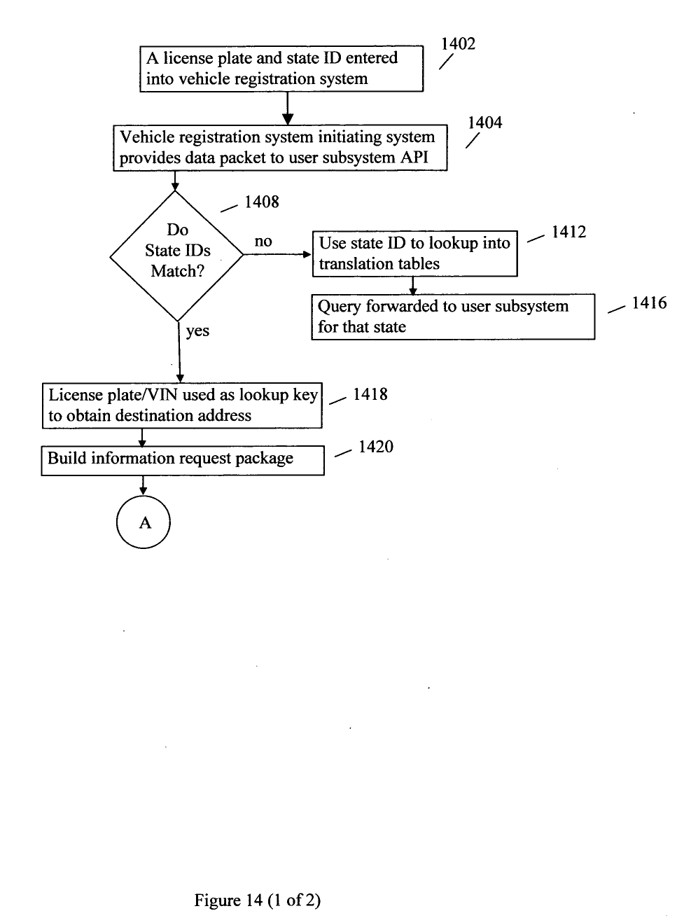

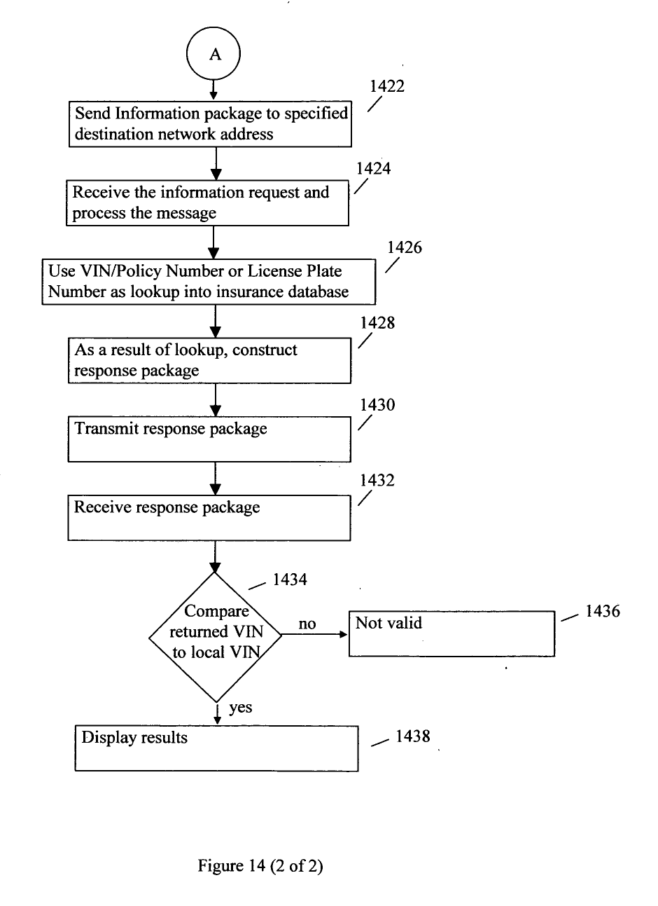

The present invention provides the following system and method of mobile enforcement insurance verification as shown in FIG. 13:
a. An insurance company Homing Tag or other suitable identifier (i.e. identifier sticker “ABC”) is applied in step 1302 to the license plate or back window of the vehicle so that it is visible to traffic to the rear. The sticker is provided to the vehicle owner (insured) along with the paper insurance card.
b. A patrol officer enters in step 1304 the license plate or VIN number of the vehicle into the in-vehicle automotive vehicle registration verification system as is typically done today. Optionally, in addition, the officer enters the Homing Tag information from the visible sticker (i.e. “ABC”).
c. Under the stored program control of the API accessed by the vehicle registration system, the Homing Tag is used as a lookup key in the locally stored translation table. The result of the lookup is the destination network address of the DSS in step 1306 associated with that insurance company and the insurance company assigned policy identifier.
d. Under the stored program control of the API accessed by the vehicle registration system, an information request package is built in step 1308 containing a security Daycode, the sender ID and sender network address, and the license plate number, VIN, and/or policy identifier.
e. The information package (query) is sent in step 1310 from the initiating user location to the specified destination network address (via UDP message or TCP/IP connection).
f. At the destination (DSS, the insurance company), stored program control receives the information request and validates the security Daycode in step 1312.
g. If the security Daycode is valid, the VIN, license plate number and/or policy identifier is used as a lookup key into the insurance company database in step 1314.
h. The insurance company database is queried locally by the DSS stored program control at the insurance company in step 1316.
i. The result of the insurance company database lookup (insurance current, expired, cancelled, not found) is constructed in step 1318 into a response package. The response package includes the security Daycode, the Sender ID, the VIN and/or license plate number, vehicle model and type, and the insurance status.
j. The response package is transmitted across the network to the User network address (via UDP or TCP/IP connection) that initiated the query.
k. The package is received by the stored program control at the initiating location in step 1320 (the in-vehicle registration verification system) and the received Sender ID is compared to the real Sender ID in step 1322
l. If the Sender IDs match, the result (insurance valid, cancelled, expired, not found) is displayed.

The present invention provides the additional following system and method of mobile enforcement insurance verification as shown in FIG. 14:
a. A patrol officer enters the license plate number of the vehicle, and the state identifier, which licensed the vehicle, into the in-vehicle automotive vehicle registration verification system in step 1402 as is typically done today.
b. Under the stored program control of the in vehicle registration system (the initiating subsystem) a data packet is provided in step 1404 to the User Subsystem API (6110) containing the license plate number of the vehicle and the VIN number of the vehicle.
c. The received state identifier is compared in step 1408 to the state ID contained in the User control Program (6200). If the state Ids do not match, the received state ID is used in step 1412 as a lookup into the translation tables for state systems (6700) providing the key to State translation and the query is forwarded in step 1416 to the User subsystem API for that state, otherwise the data packet is processed as follows:
d. License plate or VIN number is used as a lookup key in step 1418 in the locally stored translation tables (6700) providing the key (HID) to insurance company route translation and the key to unique policy number translation. The result of the lookup is the destination network address or web service signature of the DSS associated with that insurance company and the insured Insurance Company assigned policy number or policy identifier.
e. Under the stored program control (6300) an information request package is built in step 1420 containing a security Daycode, the sender ID and sender network address, and the license plate number, the VIN, and/or the insured unique policy number.
f. The information package (query) is sent in step 1422 from the initiating user location to the specified destination network address or web service using proprietary messaging or standardized methods (Web Service, RMI, JMS, HTTP, etc.).
g. At the destination (DSS, the insurance company), stored program control receives in step 1424 the information request and processes the message.
h. The VIN, policy number, and/or license plate number is used in step 1426 as a lookup key into the insurance company database.
i. The insurance company database is queried locally by stored program control at the insurance company.
j. The result of the insurance company database lookup (insurance current, expired, cancelled, not found) and VIN and/or license plate number is constructed in step 1428 into a response package. The response package includes the security Daycode, the Sender ID, the insurance company database derived VIN and/or license plate number, and the insurance status.
k. The response package is transmitted in step 1430 across the network to the User Subsystem at the network address that initiated the query.
l. The response package is received in step 1432 by the stored program control at the initiating location (User Subsystem API), processed, VIN, license plate number or unique identifier compared in step 1432, and presented to the in-vehicle registration verification system via the User subsystem API interface (6110). If the VIN, license plate number and/or unique identifier match fails, the insurance status is overridden to “not valid” in step 1436 as a method of fraud prevention.
m. The response message is processed as required by the initiating system and the results displayed in step 1438 to the officer in the field (insurance status received or failed query due to mismatched VIN).

The police officer can pull the vehicle over and issue a citation based on expired vehicle insurance and the vehicle is now subject to probable cause and all those opportunities afforded by that probable cause, that cause being the vehicle is being operated on a public road illegally because it does not have a valid insurance policy.

The system administration and maintenance function (Control/Maintenance System) generates a random number each day to be utilized as the security “day-code”. The system administration and maintenance function builds, updates, and distributes the network address table NAT (translation table) containing insurance company homing tag to insurance company DSS network address data entries to each user subsystem.

Each insurance company DSS database is accessible via stored program control at the insurance company location. The contents of the database including maintenance of the database are the responsibility of the appropriate insurance company. The system administration and maintenance function CMS pings each insurance company, contained in the HID to route translation table, every 30 minutes or other appropriate time period to verify it is on-line and to distribute the current security code (“day-code”). When each insurance company application receives the ping, it responds with a registration message containing its unique homing tag and network address. The response received from the insurance company is verified/updated in the NAT and a day-code message is sent to the insurance company application.

A new insurance company is brought on-line by the insurance company application sending a register message (authenticated message containing network address, homing ID, and unique authorization code) to the administration and maintenance function. The administration and maintenance function contains a user and a DSS authentication database for logins. The system administration and maintenance function validates the sender of the register message against the authentication database and acknowledges any validated (proper login/password sequence) unsolicited registration message with a message containing the day-code.

Users of the system must optionally log in once each day. The system maintenance function includes a user authentication database where users enter a user ID and password. After successful verification of the username and password the NAT (translation table) and day-code are downloaded to the user application. The user application may now be used to perform data requests to all insurance companies listed in the NAT. After the 24-hour period a new day-code is generated by the CMS and distributed to the insurance company applications. User applications, which utilize the stale day-code, must perform the login function again to receive the new day-code and NAT.

It is a method of this system to count data requests from each user over a period of time at the DSS (insurance company application) via a counter in the access list. Users which perform data requests at a rate greater than N (programmable value) per minute are denied system access at the insurance company application and a message is sent to the system maintenance function to log the ID of the user and disable the user login capability for M (Programmable value) minutes.

It is a part of the system and method for the User Subsystem to count successful and total data requests to each DSS (insurance company application) over a predetermined but programmable period of time at the DSS via counters in the access list. Additionally, for each successful query/response, the per-query time and total time of all successful queries is summed to determine the average and maximum query times. These counts and query times are stored in a log file by each user subsystem on a per DSS basis. The counts and time logs are transferred to the system maintenance function on a periodic basis. DSS endpoints which result in a query success rate below some predetermined but programmable threshold (i.e. 99% as determined by the user subsystem) result in an acknowledged message being sent to the system maintenance function to log the ID of the DSS and another acknowledged message being sent to the DSS so that automated problem identification methods can take place. DSS endpoints which are detected by the user subsystem as having a maximum or average query time response rate greater than some predetermined but programmable threshold (i.e. 4 seconds max and 2 seconds average) result in an acknowledged message being sent to the system maintenance function to log the ID of the DSS and another acknowledged message being sent to the DSS so that automated problem identification methods can take place between the control and maintenance subsystem and the specific DSS. The DSS is optionally disabled by the control and maintenance subsystem by updating the translation table to indicate “disabled” for that route. The translation entry is then propagated to all user subsystems whereby the user subsystem will no longer perform queries to that DSS and instead immediately return the status of “endpoint disabled” to the user subsystem or API along with insurance status of “undetermined”.
A user must be authenticated prior to allowing data server requests within the system.
Using stored program control at a user subsystem, a connection (TCP/IP) is created to the administration server (CMS) where the user is prompted to enter the user ID and password.
Upon successful authentication of user ID and password, the current day-code and NAT are transferred to the user subsystem.
The connection is terminated and the user subsystem may now begin data queries for the purpose of real time insurance verification.

A new data server (DSS) or a data server that was temporarily disabled or otherwise not accepting data queries may enter the system by interaction with the administration function.
a. A GUI at the administration function provides for manual entry of the homing tag and associated network address of the new data server subsystem (insurance company).
b. The homing tag is verified not to be a duplicate and the new network address is stored in the NAT (translation table).
c. A connection is made to the new network address and a day-code update message is sent.
d. Stored program control at the DSS location specified by the new network address receives and processes the day-code and sends an acknowledge message back to the administration function (Control and Maintenance subsystem).
e. The connection is terminated and the data server subsystem (insurance company) can now process data queries.

Periodically (preferably every 12 hours), the security day-code is updated.
a. The administration function generates a new day-code.
b. The Administration function reads each entry in the NAT and for each entry a connection is made to the network address and a day-code update message is sent.
c. Stored program control at the location specified by the network address receives and processes the day-code and acknowledges. Note that steps 2 and 3 constitute what is considered the “ping” function.
d. The connection is terminated and the data server subsystem (insurance company) can now process data queries using the new day-code.
e. To prevent user subsystem and data server subsystems being out of synchronization with respect to the day-code, the data server subsystem will process data requests by validation against the current and previous day-codes.

An overview of the system and method for automotive liability insurance compliance system is shown in FIG. 6.

There exists today, tools designed to decrease the amount of time required to implement a system with methods similar to those described in this patent application. Such tools provide a framework and building blocks with which to develop this system and methods, for example Web Services. There are also tools offered as individual building blocks by which to implement this system and methods, for example Java Beans and the various Java Enterprise components. It is understood by one skilled in the art that the system and methods described in this patent application are independent of the infrastructure upon or the environment within which the subsystems execute, thus the system and methods implemented via Web Services or some other developmental tool is not an improvement over what is described here but rather a different implementation of the same system and methods.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

1). A method for determining insurance status information for a vehicle, comprising the steps of:
obtaining an identifier for said vehicle;
using said identifier to obtain destination data where said insurance status information with respect to said vehicle is located;
using said destination data to request said insurance status information from said insurance company;
receiving a response from said insurance company including said insurance status information indicating the status of said vehicle.

2) A method for determining insurance status information for a vehicle as in claim 1, wherein said identifier includes a vehicle identification number (VIN).

3) A method for determining insurance status information for a vehicle as in claim 1, wherein said identifier includes a license plate number.

4) A method for determining insurance status information for a vehicle as in claim 1, wherein said identifier includes a homing tag (HT).

5) A method for determining insurance status information for a vehicle as in claim 1, wherein said identifier includes an insurance policy number.

6) A method for determining insurance status information for a vehicle as in claim 1, wherein said destination data is located in a translation table;

7) A method for determining insurance status information for a vehicle as in claim 1, wherein said identifier is obtained by using a barcode reader.

8) A method for determining insurance status information for a vehicle as in claim 1, wherein said method includes the step of displaying said status information.

9) A method for determining insurance status information for a vehicle as in claim 1, wherein said response includes a returned identifier.

10 A method for determining insurance status information for a vehicle as in claim 9, wherein said returned identifier is compared with a local identifier.

11) A method for determining insurance status information for a vehicle as in claim 10, wherein a match between said returned identifier and said sent identifier is based on an threshold value.

12) A method for determining insurance status information for a vehicle as in claim 1, wherein said step of obtaining said identifier includes the step of obtaining the identifier from the owner of the vehicle or a responsible party.

13) A method for determining insurance status information for a vehicle as in claim 1 wherein the step of obtaining said identifier includes the step of obtaining said identifier from a database having a plurality of different identifiers.

14) A method for determining insurance status information for a vehicle as in claim 1 wherein said insurance status information includes information whether said vehicle is currently insured.

15). A system for determining insurance status information for a vehicle, comprising:
an user subsystem for obtaining an identifier for said vehicle and using said identifier to obtain an additional identifier and destination data where said insurance status information with respect to said vehicle is located;
a network interface subsystem using said destination data and said additional identifier to request said insurance status information from said insurance company;
a data server subsystems to receive said request and determine said insurance status information from said destination data and to generate a response for said network interface subsystem;
said network interface subsystem receiving a response from said insurance status information indicating the insurance status of said vehicle;

16) A system for determining insurance status information for a vehicle as in claim 15, wherein said identifier includes a vehicle identification number (VIN).

17) A system for determining insurance status information for a vehicle as in claim 15, wherein said identifier includes a license plate number.

18) A system for determining insurance status information for a vehicle as in claim 15, wherein said identifier includes a homing tag (HT).

19) A system for determining insurance status information for a vehicle as in claim 15, wherein said additional identifier includes an insurance policy number.

20) A system for determining insurance status information for a vehicle as in claim 15, wherein said additional identifier and said destination data are located in a translation table;

21) A system for determining insurance status information for a vehicle as in claim 15, wherein said identifier is obtained by using a barcode reader.

22) A system for determining insurance status information for a vehicle as in claim 15, wherein said system includes a display to display said insurance status information.

23) A system for determining insurance status information for a vehicle as in claim 15, wherein said response includes a returned identifier.

24 A system for determining insurance status information for a vehicle as in claim 23, wherein said returned identifier is compared with a local identifier.

25) A system for determining insurance status information for a vehicle as in claim 24, wherein a match between said returned identifier and said sent identifier is based on a threshold value.

26) A system for determining insurance status information for a vehicle as in claim 25, wherein a mismatch between said returned identifier and said local identifier indicates a potentially fraudulent insurance status.

27) A system for determining insurance status information for a vehicle as in claim 15, wherein the step of obtaining said identifier includes the step of obtaining said identifier from a database having a plurality of different identifiers.

28) A system for determining insurance status information for a vehicle as in claim 15, wherein said insurance status information includes whether said vehicle is currently insured.

29). A system for determining insurance status information for a vehicle, comprising:
an user subsystem for obtaining an identifier for said vehicle and using said identifier to obtain additional identifier and destination data where said insurance status information with respect to said vehicle is located and for collecting metrics;
a network interface subsystem using said destination data to request said insurance status information from said insurance company;
a data server subsystem to receive said request and determine said insurance status information from said destination data and to generate a response for said network interface subsystem;
said network interface subsystem receiving a response from said insurance status information indicating the status of said vehicle;
an administration subsystem including a master database of identifiers for management and for communication between said user subsystem and said data server subsystem and for storing metrics received from user subsystems;

30) A system for determining insurance status information for a vehicle as in claim 29 wherein said administration subsystem includes security management for communication between said user subsystem and said data server subsystem.

31) A system for determining insurance status information for a vehicle as in claim 29 wherein said master database includes translation and local tables.

32) A system for determining insurance status information for a vehicle as in claim 29 wherein said security management is performed by measuring the rate of requests from said user subsystem.

33) A system for determining insurance status information for a vehicle as in claim 29 wherein said administration system obtains insurance query routing information from said destination data for substantially all identifiers in said master database.

34) A system for determining insurance status information for a vehicle as in claim 29, wherein said administration subsystem verifies a route to said data server subsystem from said destination data by performing insurance verifications.

35) A system for determining insurance status information for a vehicle as in claim 29 wherein said metrics include the number of successful queries to each data server subsystem, the total number of queries to each data server subsystem, the average response time, and the maximum response time from said data server subsystem.

36) A system for determining insurance status information for a vehicle as in claim 33 wherein said master database includes modifications from at least one insurance company using said network interface subsystem.

37) A system for determining insurance status information for a vehicle as in claim 29 wherein said destination data includes query routing information in said master database which is deleted to reflect a policy cancellation from said insurance company.

38) A system for determining insurance status information for a vehicle as in claim 29 wherein said destination data includes routing information in said master database which is created to reflect a policy creation from said insurance company.

39) A system for determining insurance status information for a vehicle as in claim 29 wherein said destination data includes routing information in said master database which is updated to reflect a policy renewal from said insurance company.

40) A system for determining insurance status information for a vehicle as in claim 36 wherein said modifications to said master database are stored in a policy cancellation list with timestamps.

41) A system for determining insurance status information for a vehicle as in claim 40 where after a predetermined time period said stored policy cancellation list is compared against a policy creation list in said master database to indicate a cancelled policy with no corresponding created policy.

42) A method for determining insurance status information for a vehicle as in claim 11, wherein a mismatch between said returned identifier and said sent identifier indicates a potential fraudulent insurance status.

43) A method for determining insurance status information for a vehicle as in claim 10, wherein said returned and sent identifiers include the vehicle identification number.

44) A method for determining insurance status information for a vehicle as in claim 10, wherein said returned and local identifiers include a unique assigned value.

45) A system for determining insurance status information for a vehicle as in claim 15 where said system includes an application programming interface to allow the user subsystem to interact with an external system including a state vehicle registration database for insurance status verification of substantially all the vehicles included in the that vehicle registration database.

46) A system for determining insurance status information for a vehicle as in claim 15, wherein said user subsystem includes a local table including said insurance status.

47) A system for determining insurance status information for a vehicle as in claim 45, wherein said application programming interface performs an insurance verification for each entry in the external system containing the state vehicle registration database.

48) A system for determining insurance status information for a vehicle as in claim 25, wherein a mismatch between said returned identifier and said local identifier results in an identifier update message containing the local identifier being sent to said insurance company.
